(19) United States
(12) Patent Application Publication
(10) Pub. No.: US 2025/0065676 A1
(43) Pub. Date: Feb. 27, 2025

(54) SYSTEM, METHOD, AND APPARATUS FOR MAINTAINING A TIRE INFLATION PRESSURE

(71) Applicant: BRIDGESTONE AMERICAS TIRE OPERATIONS, LLC, Nashville, TN (US)

(72) Inventor: Francis J. Byrne, College Grove, TN (US)

(73) Assignee: BRIDGESTONE AMERICAS TIRE OPERATIONS, LLC, Nashville, TN (US)

(21) Appl. No.: 18/725,093

(22) PCT Filed: Dec. 22, 2022
(86) PCT No.: PCT/US22/82218

§ 371 Date: Jun. 27, 2024

Related U.S. Application Data
(60) Provisional application No. 63/294,134, filed on Dec. 28, 2021.

(51) Int. Cl. B60C 23/00; B60B 1/00

(52) U.S. Cl. CPC B60C 23/004; B60B 1/00

(57) ABSTRACT

In one aspect, a passive tire inflation device is provided, comprising: a reservoir, a migration chamber containing a migration plug, and a post-plug outlet, wherein the migration chamber is fluidically connected to the reservoir, wherein the migration chamber is fluidically connected to the post-plug outlet, and wherein the migration plug is formed from a rubber compound. In another aspect, a tire and wheel assembly including a passive tire inflation device is provided, comprising: a vehicle wheel including a rim and at least one spoke, a tire mounted on the vehicle wheel forming a tire air chamber, the device comprising: a reservoir, a migration chamber containing a migration plug, and a post-plug outlet, wherein the post-plug outlet is fluidically connected to the tire air chamber. The device may be attached to or contained within at least one wheel spoke. The device may extend circumferentially about the wheel rim.

### CROSS-REFERENCE TO RELATED APPLICATIONS

This application claims priority from U.S. Provisional Patent Application No. 63/294,134, filed on Dec. 28, 2021, which is incorporated by reference herein in its entirety.

### BACKGROUND

Vehicle tires are generally designed with a specified operating air pressure, or range of air pressures (design maximum and minimum air pressures), often dependent upon application, vehicle specifications (e.g., size and weight). Operating the tire below the specified operating pressure can have negative effects upon the performance and life of the tire.

Operating a tire below the design tire pressure can affect rolling resistance of the tire, which in turn may affect fuel economy. Some vehicles, including for example, tractor trailers, have numerous tires, and an increase in rolling resistance in many or all of these tires can have significant effects on the fuel economy of that vehicle as a whole. A fleet of those vehicles, experiencing decreased fuel economy due to underinflation, may lead to significant extra expenses for fuel for an organization operating that fleet. Maximizing fuel economy is also an important consideration in the electric vehicle market, wherein the already limited range of the electric vehicle may be negatively impacted by tires experiencing more rolling resistance due to underinflation. Thus, operating a vehicle with underinflated tires may directly increase one's carbon footprint.

Vehicle tires that are mounted and inflated to that specified operating pressure experience a pressure drop (perhaps around 2% pressure loss per month). This pressure loss has a mostly consistent rate and is a result of migration of inflation gas molecules through the tire carcass. That is, the inflation gas molecules migrate through the tire itself and into the ambient atmosphere. To mitigate this natural pressure loss, tires typically include a component such as a bladder or butyl innerliner, which typically acts to reduce the rate of pressure loss. However, even with such measures in place, tires still consistently lose inflation pressure due to the tire's natural inability to contain all of the inflation gas molecules.

Typically, the larger the tire, the greater the loss of inflation pressure through the tire due to migration of inflation gas molecules. Additionally, the load index of the tire, derived from the air cavity size of the tire, is typically a factor for the rate of inflation pressure lost through the tire due to migration of inflation gas molecules. That is, the larger the load index, the higher the rate of loss of inflation pressure.

Thus, the inflation pressure of vehicle tires must be regularly checked (e.g., it is recommended to check tire pressure weekly or monthly), and replaced, to keep the tire's inflation pressure at the specified operating pressure. However, this monitoring and maintenance of tire air pressure is often overlooked, and may be time-consuming on larger vehicles with a larger number of tires and/or fleets of vehicles.

What is needed is a passive device capable of replacing the inflation gas that is naturally lost from vehicle tires.

### SUMMARY

In one aspect, a passive tire inflation device is provided, the device comprising: a reservoir, a migration chamber containing a migration plug, and a post-plug outlet, wherein the migration chamber is fluidically connected to the reservoir, wherein the migration chamber is fluidically connected to the post-plug outlet, and wherein the migration plug is formed from a rubber compound.

In another aspect, a tire and wheel assembly including a passive tire inflation device is provided, the assembly comprising: a vehicle wheel including a rim and at least one spoke, a tire mounted on the vehicle wheel forming a tire air chamber, the device comprising: a reservoir, a migration chamber containing a migration plug, and a post-plug outlet, wherein the post-plug outlet is fluidically connected to the tire air chamber.

In another aspect, a tire and wheel assembly including a passive tire inflation device is provided, the assembly comprising: a vehicle wheel including a rim and at least one spoke, a tire mounted on the vehicle wheel forming a tire air chamber, the device comprising: a reservoir extending circumferentially about the rim, a migration chamber containing a migration plug, and a post-plug outlet, wherein the post-plug outlet is fluidically connected to the tire air chamber.

### BRIEF DESCRIPTION OF THE DRAWINGS

The accompanying figures, which are incorporated in and constitute a part of the specification, illustrate various example aspects, and are used merely to illustrate various example aspects. In the figures, like elements bear like reference numerals.

FIG. 1 illustrates a graph showing tire inflation pressure loss over the course of 24 months.

FIG. 2 illustrates a schematic of a passive tire inflation system 200.

FIG. 3A illustrates a perspective view of a passive tire inflation device 310.

FIG. 3B illustrates a perspective view of passive tire inflation device 310.

FIG. 3C illustrates a sectional view of passive tire inflation device 310.

FIG. 3D illustrates a partial sectional view of passive tire inflation device 310.

FIG. 3E illustrates a perspective view of a migration plug 306 and a restriction plate 318.

FIG. 3F illustrates a perspective view of migration plug 306 and restriction plate 318.

FIG. 4 illustrates a schematic of a passive tire inflation device 410.

FIG. 5A illustrates a perspective view of a tire and wheel assembly 520 including a passive tire inflation device 510.

FIG. 5B illustrates a sectional view of tire and wheel assembly 520 including passive tire inflation device 510.

FIG. 5C illustrates a partial sectional view of tire and wheel assembly 520 including passive tire inflation device 510.

FIG. 5D illustrates a sectional view of tire and wheel assembly 520 including passive tire inflation device 510.

FIG. 6A illustrates a perspective view of a tire and wheel assembly 620 including a passive tire inflation device 630.

FIG. 6B illustrates a sectional view of tire and wheel assembly 620 including passive tire inflation device 630.

FIG. 6C illustrates a partial sectional view of tire and wheel assembly 620 including passive tire inflation device 630.

FIG. 6D illustrates a sectional view of tire and wheel assembly 620 including passive tire inflation device 630.

### DETAILED DESCRIPTION

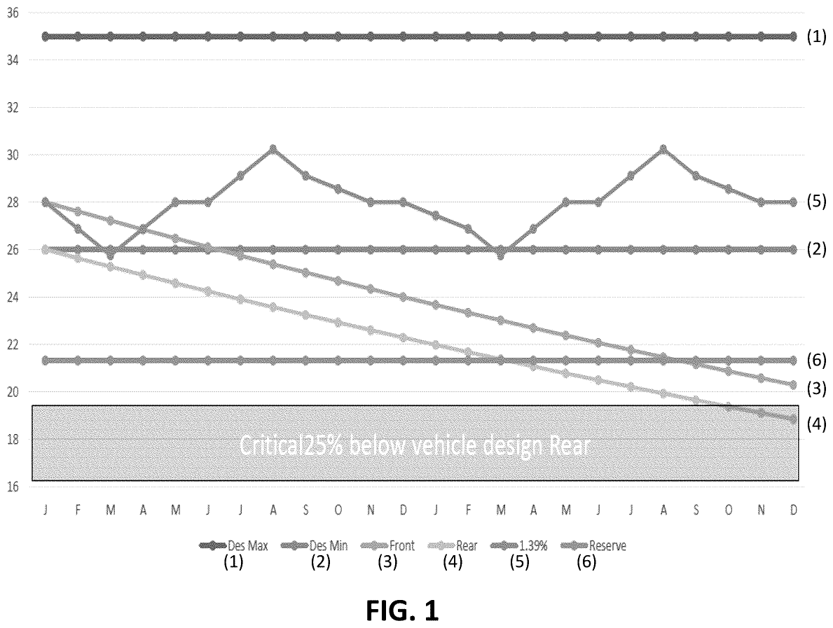

FIG. 1 illustrates a graph showing tire inflation pressure loss over the course of 24 months. The graph illustrates the design maximum pressure (1), minimum pressure (2), and reserve minimum pressure (6), as well as the pressure of a front tire (3) and a rear tire (4) on a vehicle during that 24 month period, and finally a fluctuation based only upon pressure increase and decrease due to temperature changes (5) (and not accounting for a tire's natural leakage due to molecular migration of the contained air). As illustrated, a tire initially inflated to 28 psi is outside of design limits (below minimum pressure) in just over a year due to inflation loss. In a real world case, a tire's pressure would be a combination of lines (3) and (5), or lines (4) and (5), experiencing both pressure loss due to the natural molecular migration of the contained air, as well as the pressure fluctuation experienced by the tire's contained air due to temperature fluctuation throughout the year.

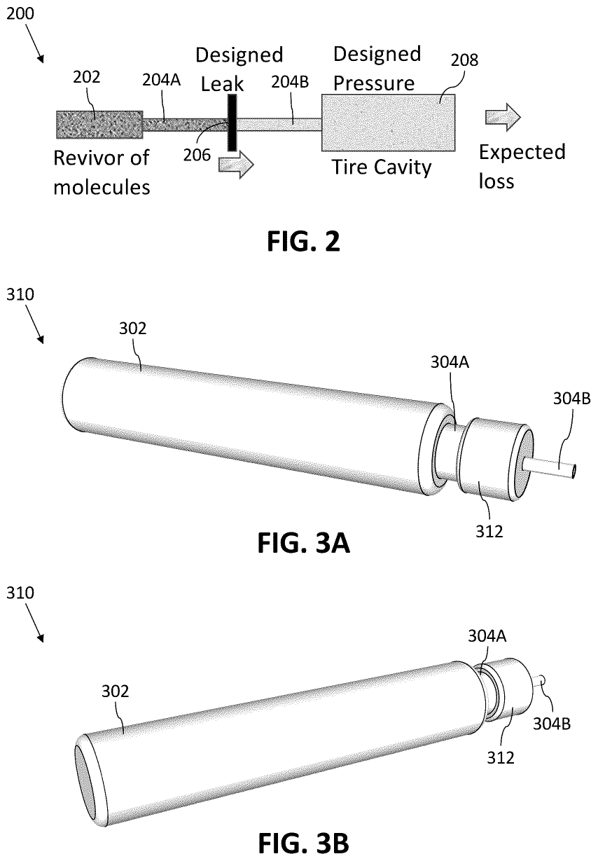

FIG. 2 illustrates a schematic of a passive tire inflation system 200. System 200 includes a reservoir 202, a pre-plug inlet 204A, a migration plug 206, a post-plug outlet 204B, and a tire air chamber 208.

Reservoir 202 may be a container that is sealed other than an aperture that is in fluid communication with inlet 204A. Reservoir 202 may be formed from an air impermeable material. Reservoir 202 may contain a fluid, including without limitation, a liquid such as liquid nitrogen, a gas, an inert gas, or the like. Reservoir 202 may contain a pressurized fluid, including without limitation, a pressurized liquid such as liquid nitrogen, a pressurized gas, an inert gas, or the like. Use of a high density liquid form of nitrogen may allow the reservoir 202 to be smaller than if used with a gas form of a fluid. System 200 may remove the need for compression of local air with contaminants such as H₂O or O₂ that may damage sensors, wheels, and/or the tire. Using an inert gas, such as CO₂, N₂, or the like, may act to extend the life of the tire. Reservoir 202 (and all like reservoirs discussed herein) may be replaced or refilled upon exhausting the supply of pressurized fluid contained therein.

In one aspect, the use of nitrogen gas within the tire may have many benefits. For example, as nitrogen is inert, it is not prone to damaging the metal within the tire or wheel. Other gases, such as oxygen, oxidize and react negatively with these metal elements. Additionally, nitrogen has a larger molecular size than other gases, such as oxygen, and thus migrates more slowly through the molecular matrix of the tire.

The use of other gases, including for example atmospheric air (which is a mixture of many molecules), may be problematic as the smaller molecules in the air migrate quicker out of the tire, leaving the larger molecules. This results in a pressure loss that is not constant, and rather, has a higher rate at first (as the small molecules quickly escape the tire), and a lower rate later (as the remaining larger molecules take longer to escape the tire).

Inlet 204A includes a hollow tube or aperture configured to permit a fluid from reservoir 202 to travel through inlet 204A and into contact with migration plug 206. Migration plug 206 may be formed from any of a variety of polymers, including without limitation, a rubber compound used in an actual tire. Migration plug 206 may include a fiber reinforced rubber to maintain the size and shape of plug 206.

Migration plug 206 may receive a fluid on its first end (the end in contact with reservoir 202), and via the natural migration of the molecules being dissolved through the tire, will allow a fluid to slowly pass through plug 206, into outlet 204B, and finally into tire air chamber 208. The aforementioned natural migration may be the same natural migration of particles that causes a tire to gradually lose inflation pressure as discussed above, only instead of air particles migrating out of the tire's air chamber and into the ambient atmosphere, the air particles migrate from reservoir 202 into tire air chamber 208. In one aspect, the fluid inside reservoir 202 may be a liquid nitrogen, and thus the fluid contacting plug 206 is in liquid form on the inlet 204A side of plug 206, but is in a gas form on the outlet 204B side of plug 206. Boyle's Law dictates the phase (liquid or gas) of the fluids in question.

Because plug 206 may be formed from a tire compound, plug 206 is subject to the same migration rate variations due to temperature fluctuations that are experienced in the rest of the tire. Plug 206 may be made from a compound, or compounds, that is the same as a compound, or compounds, used in the remainder of the tire. That is, plug 206 and the subject tire react in the same manner to temperature fluctuations, such that if the tire is losing air to the ambient atmosphere quicker due to a temperature, then plug 206 is refilling the tire quicker due to the same temperature. The advantage of using a tire compound for plug 206 is that plug 206 will behave, from a temperature fluctuation standpoint, like the remainder of the tire.

Plug 206 may have a size, shape, thickness, and compound selected to mimic the rate of migration experienced by the tire. That is, if the tire loses 2% inflation pressure per month, then plug 206 is designed to add 2% inflation pressure back into the tire each month. As illustrated in FIG. 2, plug 206 may be designed such that “designed leak” is equal to “expected loss,” to maintain tire air chamber 208 at “designed pressure.” Plug 206 and system 200 may be designed for a specific tire, tire segments, tire load ratings, tire load indexes (load index is dependent upon air volume within tire air chamber 208), or the like, such that the same plug 206 and system 200 may be used on one specific tire, a segment of tires, tires of the same load ratings, tires of the same load indexes, or the like. A plug 206 and/or a system 200 may thus be compatible with various tire brands for universal application.

As migration of the contents of reservoir 202 is dependent upon migration, rather than a pressure differential between reservoir 202 and tire air chamber 208, the pressure inside of reservoir 202 has no effect on the rate of migration. Also, because the rate of migration is not dependent upon a pressure differential, the rate of migration does not change as the pressure of a fluid in reservoir 202 decreases over time, through the life of reservoir 202 and/or system 200.

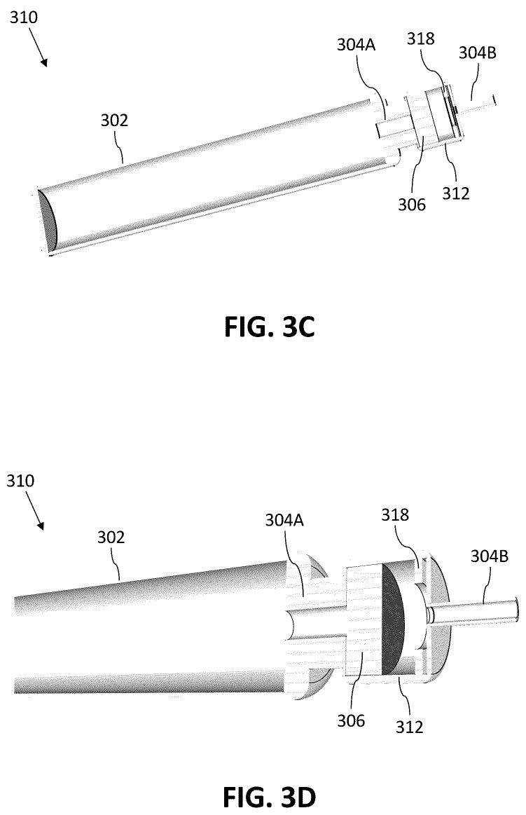

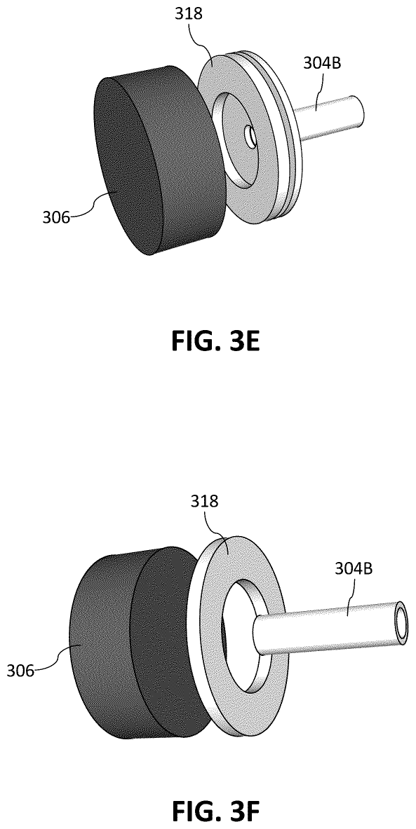

FIGS. 3A-3F illustrate a passive tire inflation device 310. Device 310 includes a reservoir 302, a pre-plug inlet 304A, a migration plug 306, and a post-plug outlet 304B.

Migration plug 306 may be contained within a migration chamber 312. Device 310 may additionally include a restriction plate 318 oriented within migration chamber 312 with plug 306. Migration chamber 312 may be fluidically connected to inlet 304A and outlet 304B. Inlet 304A may extend between reservoir 302 and chamber 312.

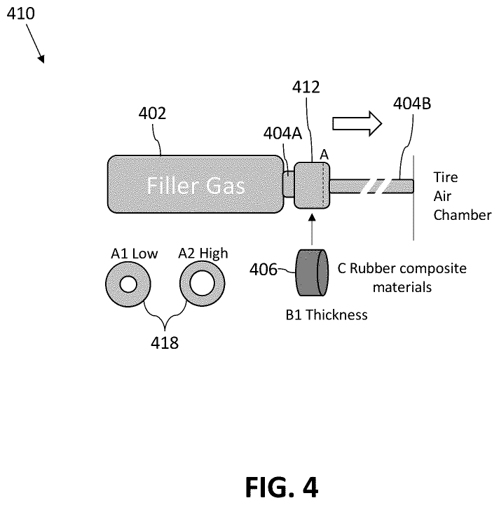

Restriction plate 318 may be a disk, plate, or the like, having one or more orifice within it that permits gas to flow through plate 318 after migration through plug 306. Varying the size and/or number of orifices within restriction plate 318 will vary the flow rate of gas from migration chamber 312 into outlet 304B. As illustrated in FIG. 4, restriction plates 418 may have different sized orifices, such that a restriction plate 418 with a smaller orifice has a lower flow rate, while a restriction plate 418 with a larger orifice has a higher flow rate.

FIG. 4 illustrates a schematic of a passive tire inflation device 410. Device 410 includes a reservoir 402, a pre-plug inlet 404A, a migration chamber 412, a migration plug 406, a post-plug outlet 404B, and one or more restriction plates 418. The flow rate of gas into the tire air chamber may be increased or decreased through varying one or more of the following: (A) the size of migration chamber 412, (A1, A2) the size of the orifice(s) within one or more restriction plates 418 contained within migration chamber 412, (B1) the thickness of migration plug 406, and (C) the rubber/polymer composite material. The thicker plug 406, the lower the migration rate. The higher the cross-sectional area of plug 406 and/or migration chamber 412, the higher the migration rate. The larger and/or higher number of the orifice(s) within restriction plate 418, the higher the migration rate.

Any of post-plug outlets 204B, 304B, and 404B may be fluidically connected to the interior of a tire air chamber. Any of post-plug outlets 204B, 304B, and 404B may be fluidically connected to a tire fill valve, a vehicle rim, or contained wholly within the interior of a tire air chamber.

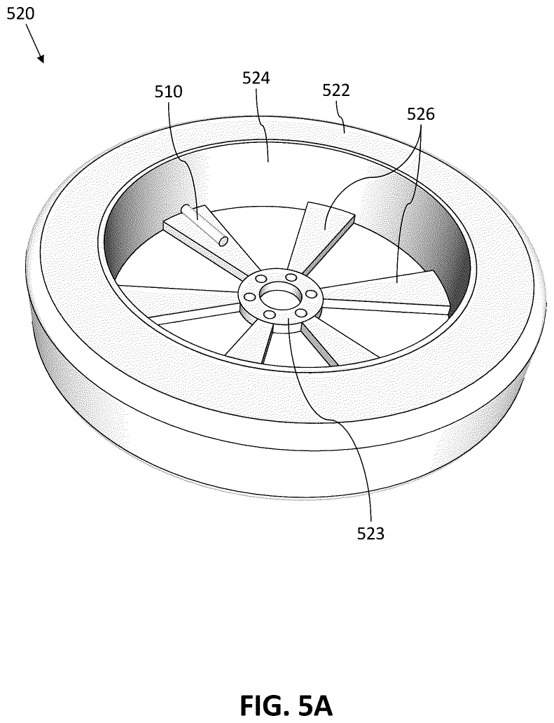

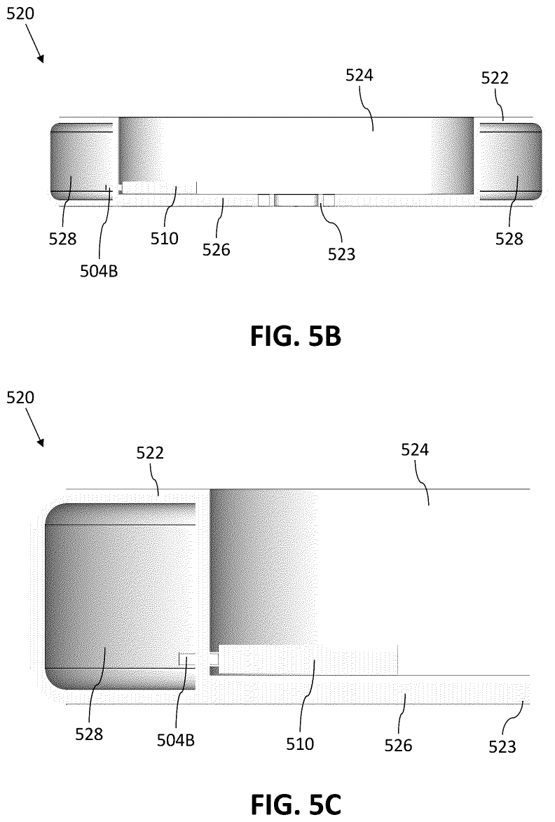

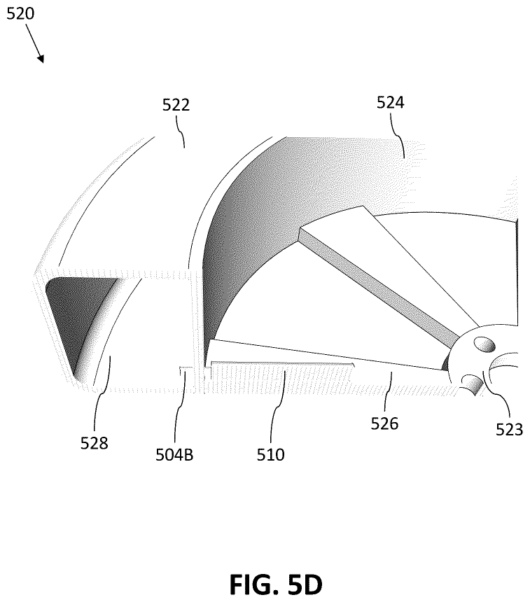

FIGS. 5A-5D illustrate a tire and wheel assembly 520 including a passive tire inflation device 510. Assembly 520 includes a tire 522 mounted on a vehicle wheel 523. Wheel 523 includes a rim 524 and at least one spoke 526. Assembly 520 may include at least one device 510. As illustrated in FIGS. 5B-5D, at least one device 510 may be attached to at least one spoke 526, and the at least one device 510 includes a post-plug outlet 504B fluidically connected to and/or extending through rim 524. In this manner, the interior of outlet 504B is fluidically connected to the tire air chamber 528.

Alternatively, one or more device 510 may be contained within one or more spoke 526 rather than simply being connected to one or more spoke 526. One or more device 510 may be oriented on the inboard side of one or more spoke 526, both to conceal and protect device(s) 510.

Device 510 may be substantially the same as one or both of devices 310 and 410.

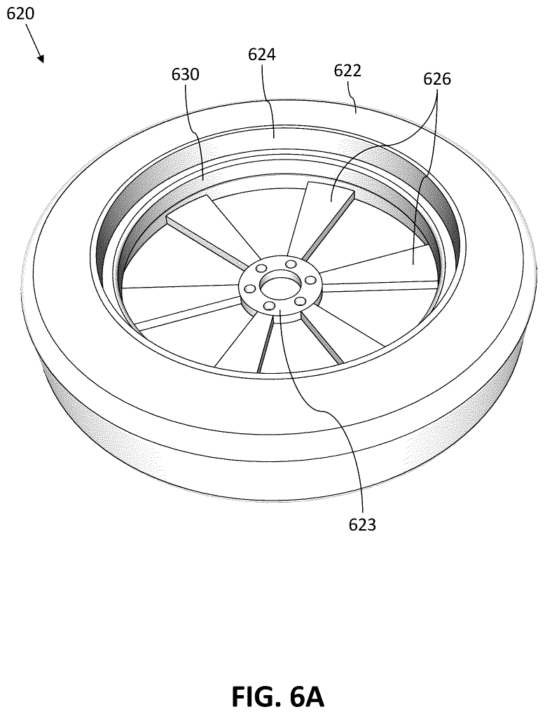

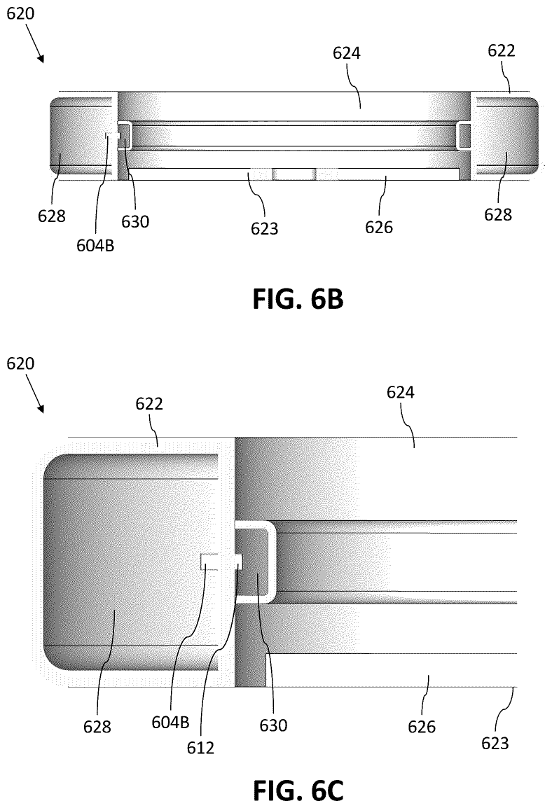

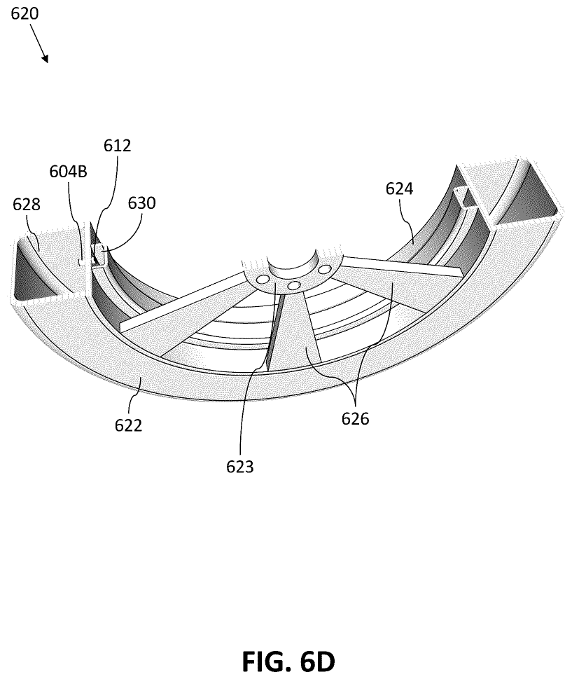

FIGS. 6A-6D illustrate a tire and wheel assembly 620 including a passive tire inflation device 630. Assembly 620 includes a tire 622 mounted on a vehicle wheel 623. Wheel 623 includes a rim 624 and at least one spoke 626. Assembly 620 may include at least one device 630. As illustrated in FIGS. 6B-6D, at least one device 630 may be attached to, or integrated into, rim 624, and the at least one device 630 includes a migration chamber 612, and a post-plug outlet 604B fluidically connected to and/or extending through rim 624. The interior of outlet 604B is fluidically connected to the tire air chamber 628.

Device 630 may include a reservoir extending circumferentially about the radially inner side of rim 624, forming an annular reservoir functioning the same way as reservoir 202, 302, and 402. Alternatively, device 630 may include a reservoir extending circumferentially about the radially outer side of rim 624 (inside of tire air chamber 628), forming an annular reservoir functioning the same way as reservoir 202, 302, and 402. Alternatively, device 630 may include one or more reservoir extending circumferentially about the radially inner side and/or radially outer side of rim 624.

Device 630 includes a migration chamber 612, which includes one or both of a migration plug (not shown) and one or more restriction plate (not shown). The arrangement and function of migration chamber 612 may be substantially the same as migration chamber 312 and/or 412. The plugs may be substantially the same as plugs 206, 306, and/or 406. The restriction plates may be substantially the same as restriction plates 318 and/or 418.

The use of the passive inflation systems and devices described herein may permit tires to be manufactured without the inclusion of a tire innerliner. The tire innerliner is tasked with helping to mitigate the migration of gas molecules from the interior of the tire air chamber into the ambient environment. The innerliner makes up approximately 10% of the weight of the tire, so elimination of the innerliner will lower the weight of the tire. The innerliner additionally helps to insulate the tire and makes it harder for the tire to shed heat. Elimination of the innerliner may make the tire shed heat more easily. Finally, the innerliner is often the most expensive compound contained in the tire. Elimination of the innerliner may decrease the cost of making the tire.

The use of the passive inflation systems and devices described herein may target as little as 0.5% to 3% loss of inflation pressure per month where the innerliner remains, and as much as 20% loss of inflation pressure per month where the innerliner is eliminated.

The use of the passive inflation systems and devices described herein may be used with running tires or spare tires. The use of the passive inflation systems and devices described herein may be used with any of a variety of types of tires, including off-the-road tires (e.g., mining tires or heavy equipment tires), aircraft tires, truck and bus radial tires, agricultural tires, passenger tires, truck tires, and the like.

The use of the passive inflation systems and devices described herein may help alter tire pressure management from a “check” item to a “maintenance” item, where a technician simply replaces or refills the system reservoir at some time interval, which may be combined with other maintenance items, such as rotating the tires, changing oil or filters, and the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments and aspects thereof, and while the embodiments and aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A passive tire inflation device, comprising:
a reservoir,
a migration chamber containing a migration plug, and
a post-plug outlet,
wherein the migration chamber is fluidically connected to the reservoir,
wherein the migration chamber is fluidically connected to the post-plug outlet, and
wherein the migration plug is formed from a rubber compound.

2. (canceled)

3. The passive tire inflation device of claim 1, wherein the reservoir contains an inert gas.

4. The passive tire inflation device of claim 1, further comprising a pre-plug inlet oriented between the reservoir and the migration chamber.

5. The passive tire inflation device of claim 1, wherein the post-plug outlet is fluidically connected to a tire air chamber.

6. The passive tire inflation device of claim 1, further comprising at least one restriction plate oriented within the migration chamber between the migration plug and the post-plug outlet.

7. The passive tire inflation device of claim 6, wherein the restriction plate includes at least one orifice.

8. A tire and wheel assembly including a passive tire inflation device, comprising:
a vehicle wheel including a rim and at least one spoke,
a tire mounted on the vehicle wheel forming a tire air chamber,
the device comprising:
a reservoir,
a migration chamber containing a migration plug, and
a post-plug outlet,
wherein the post-plug outlet is fluidically connected to the tire air chamber.

9. (canceled)

10. The tire and wheel assembly of claim 8, further comprising a pre-plug inlet oriented between the reservoir and the migration chamber.

11. The tire and wheel assembly of claim 8, further comprising at least one restriction plate oriented within the migration chamber between the migration plug and the post-plug outlet.

12. The tire and wheel assembly of claim 11, wherein the restriction plate includes at least one orifice.

13. The tire and wheel assembly of claim 8, wherein the device is attached to at least one spoke.

14. The tire and wheel assembly of claim 8, wherein the device is contained within at least one spoke.

15. The tire and wheel assembly of claim 8, wherein the post-plug outlet extends through the rim.

16. A tire and wheel assembly including a passive tire inflation device, comprising:
a vehicle wheel including a rim and at least one spoke,
a tire mounted on the vehicle wheel forming a tire air chamber,
the device comprising:
a reservoir extending circumferentially about the rim,
a migration chamber containing a migration plug, and
a post-plug outlet,
wherein the post-plug outlet is fluidically connected to the tire air chamber.

17. (canceled)

18. The tire and wheel assembly of claim 16, further comprising a pre-plug inlet oriented between the reservoir and the migration chamber.

19. The tire and wheel assembly of claim 16, further comprising at least one restriction plate oriented within the migration chamber between the migration plug and the post-plug outlet.

20. The tire and wheel assembly of claim 19, wherein the restriction plate includes at least one orifice.

21. The tire and wheel assembly of claim 16, wherein the reservoir extends circumferentially about the radially inner side of the rim.

22. The tire and wheel assembly of claim 16, wherein the post-plug outlet extends through the rim.

23. The tire and wheel assembly of claim 16, wherein the reservoir extends circumferentially about the radially outer side of the rim.
